(19) United States
(12) Patent Application Publication
(10) Pub. No.: US 2006/0122894 A1
(43) Pub. Date: Jun. 8, 2006

(54) User configured order status updates

(76) Inventors: Jon McGary, Round Rock, TX (US); Bradley Smith, Austin, TX (US)

Correspondence Address: HAMILTON & TERRILE, LLP, P.O. BOX 203518, AUSTIN, TX, 78720, US

(21) Appl. No.: 11/004,302

(22) Filed: Dec. 3, 2004

(51) Int. Cl. G06Q 30/00

(52) U.S. Cl. 705/26

(57) ABSTRACT

A method for providing user configurable order status updates which includes presenting a plurality of status update options, enabling a user to selectively choose from the plurality of status update options, and providing a customer with status updates based upon the status update options selected by the customer.

### BACKGROUND OF THE INVENTION

1. Field of the Invention

The present invention relates to order status updating and more particularly to user configurable order status updates.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A first generation web based on-line store provided a customer with an ability to select a base information handling system, customize the system and price it. Such an on-line store focused initially upon the bare necessities. That is, build a system and get a price. A configurator allowed the customer to customize and procure the system on-line. The configurator allowed the customer to select a given system model and to customize the system according to the user selected options. Such a configurator was most well received by knowledgeable customers, that is, those who were very self-sufficient without the assistance of a sales representative.

Known on-line stores included a web objects based application providing the capability to custom configure and order a particular system. The initial on-line store application offered customers the ability to select and price key system options, the ability to include multiple systems on a single order, and the ability to provide information necessary for the placement of a standard system order.

The capability to self-select system options and then price the options was provided via an on-line configurator. This configurator enabled customer selection of key, system-defining components from a display of available system options for a chosen system. The display of available options included the presentation of a “delta” price, wherein a change in system price was affected by selection of an option. The configurator provided the ability to update overall system priced based upon selections made. The capability to include multiple items in a single order was afforded by the presence of a “shopping cart”, wherein the shopping cart represents an equivalent to the traditional shopping cart. The shopping cart enabled customers to group disparate systems together as an order, as well as specify a quantity for each individual system to be included on the order. Furthermore, the capability to provide customer-specific information required for the placement of a standard order was provided via an on-line “checkout”, the checkout including essentially a form for facilitating the capture of requested and required information. The checkout form included simple logic rules to assure entry of the required fields.

Known systems might provide a notification when the order system shipped. Additionally, some types of shipping methods enable a customer to access a status page which provides an indication of an actual location of a shipped order.

### SUMMARY OF THE INVENTION

In accordance with the present invention, a system is disclosed in which a customer can select various milestones for which the customer desires notification and also can select a notification method by which the notification can be received.

In one embodiment, the invention relates to a method for providing user configurable order status updates which includes presenting a plurality of status update options, enabling a user to selectively choose from the plurality of status update options, and providing a customer with status updates based upon the status update options selected by the customer.

In another embodiment, the invention relates to an apparatus for providing user configurable order status updates which includes means for presenting a plurality of status update options, means for enabling a user to selectively choose from the plurality of status update options, and means for providing a customer with status updates based upon the status update options selected by the customer.

In another embodiment, the invention relates to a system for providing user configurable order status updates which includes a presenting module, a selection module, and a status update module. The presenting module presents a plurality of status update options. The selection module enables a user to selectively choose from the plurality of status update options. The status update module provides a customer with status updates based upon the status update options selected by the customer.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a system block diagram of an information handling system.

FIG. 4 shows a flow chart of a system for providing user configurable order status updates.

FIG. 5 shows a flow chart of a milestone portion of the system for providing user configurable order status updates.

FIG. 6 shows a flow chart of a notification portion of the system for providing user configurable order status updates.

### DETAILED DESCRIPTION

An on-line store is one component of an Internet website to which a customer may go to configure a particular information handling system, for example, according to desired options of the customer. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

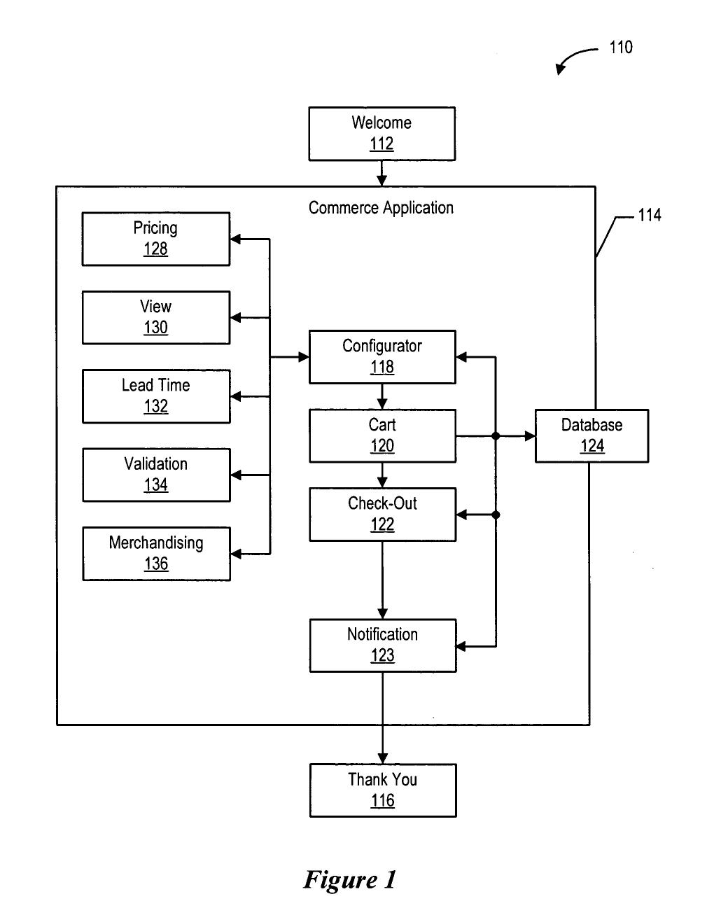

Referring now to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a notification module 123 and database 124. The database 124 provides information to the configurator 118, shopping cart 120, checkout module 122 and services activation module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and services activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the notification module 123 presents a notification page, and the thank you module 116 presents a thank you page. The welcome page includes a static page and generally resides outside of the commerce application 114. The configurator page, shopping cart page, checkout page and notification page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a notification page in which the customer is provided an opportunity select various notification options. After completion of the notification module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and notification module 123 are each part of the commerce application 114 and interact with the database 124. For example, with the shopping cart 120, additional merchandising information associated with a particular system which has been configured and placed in the shopping cart by an on-line store customer can be provided.

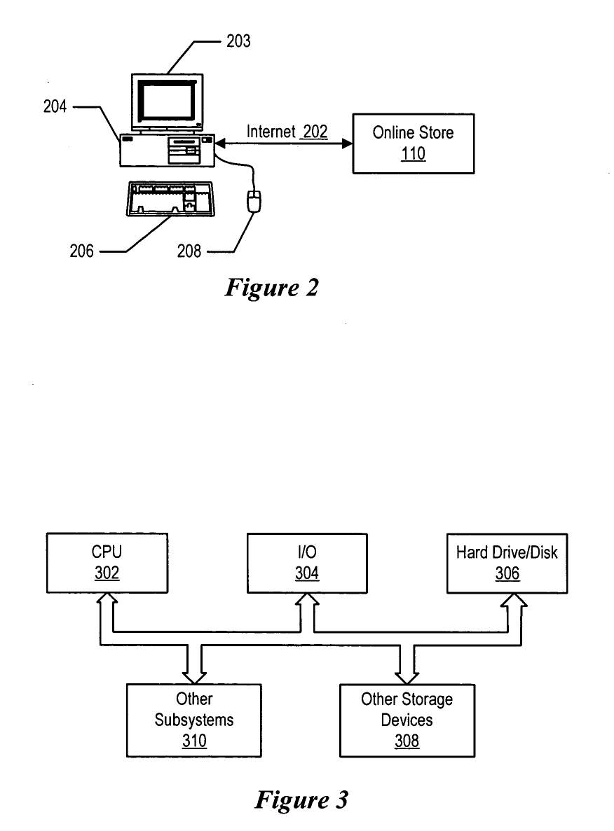

Referring to FIG. 2, a customer can access the on-line store 110 using any suitable computer equipment 200, via the Internet 202. The computer equipment 140 may include a display 203, computer 204, keyboard 206, and pointing device 208. Display 203 is used for displaying the various pages of the on-line store while a customer is using the on-line store.

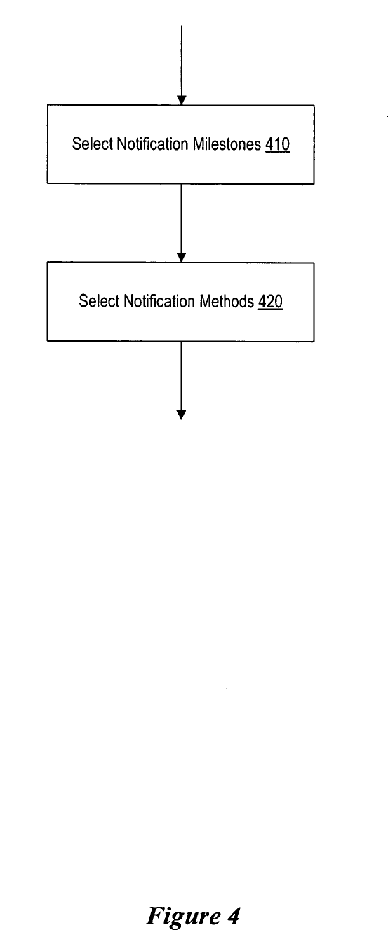

Referring briefly to FIG. 3, a system block diagram of an information handling system 150 is shown having features thereof configured in accordance with the on-line store 110 as discussed herein. The information handling system 150 includes a processor 302, input/output (I/O) devices 304, such as a display, a keyboard, a mouse, and associated controllers, non-volatile memory such as a hard disk drive 306, and other storage devices 308, such as a floppy disk and drive and other memory devices, and various other subsystems 310, all interconnected via one or more buses, shown collectively as bus 312. Service information, such as registration information, is stored on non-volatile memory of the information handling system such as the hard disk drive 306.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

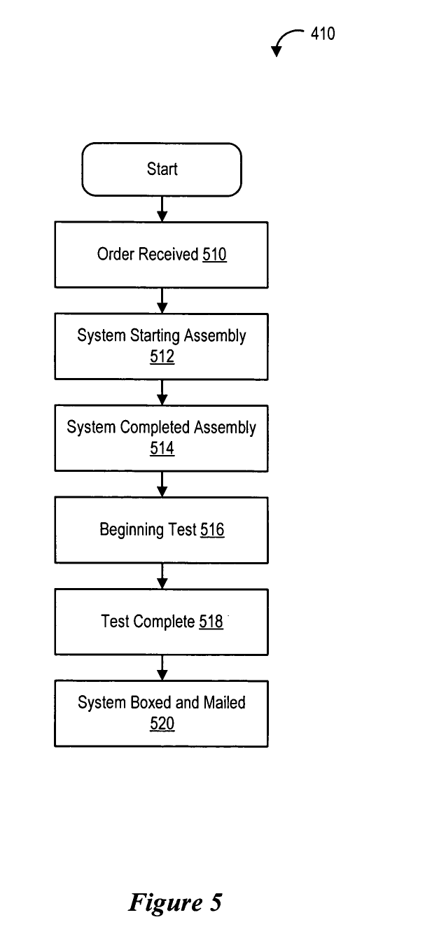

Referring to FIG. 4, a flow chart of a system for providing user configurable order status updates is shown. More specifically, a customer is presented with the option of selecting particular milestones for which the customer would like to be notified at step 410. After the customer identifies particular milestones for which the customer would like to be notified, the customer is presented with the option of selecting particular methods by which the customer would like to be notified of the selected milestones at step 420.

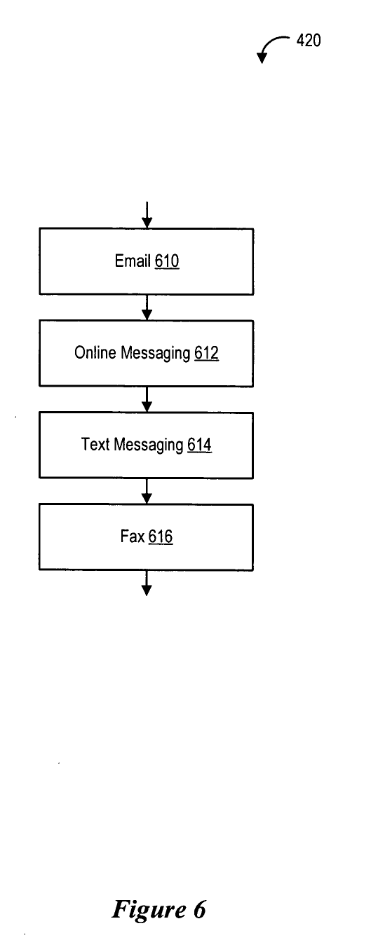

Referring to FIG. 5, a flow chart of a milestone portion 410 of the system for providing user configurable order status updates is shown. The customer can select none, some or all of various milestones within a manufacturing process for which the customer would like to receive completion notifications. More specifically, the customer might select to receive notification when an order received milestone is completed at step 510, the customer might select to receive notification when a system starts assembly milestone is completed at step 512, the customer might select to receive notification when a system completes assembly milestone is completed at step 514, the customer might select to receive notification when a enters testing milestone is completed at step 516, the customer might select to receive notification when a system completes testing milestone is completed at step 518, and the customer might select to receive notification when the ordered system is boxed and mailed milestone is completed at step 520.

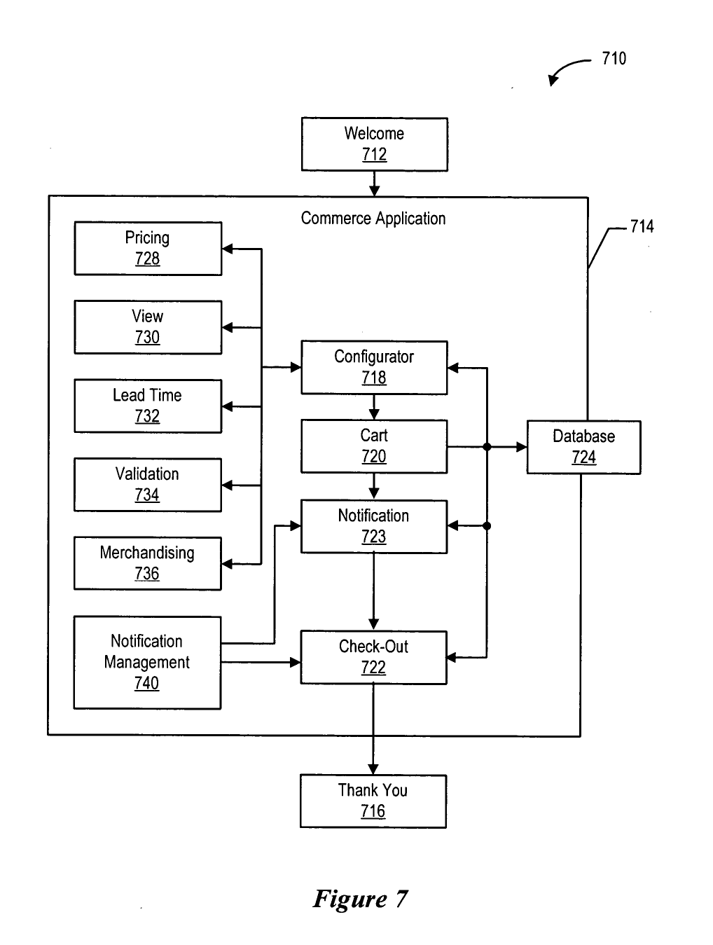

Referring to FIG. 6, a flow chart of a notification portion 420 of the system for providing user configurable order status updates is shown. The customer can select none, some or all of various notification methods by which the customer would like to receive the selected completion notifications. More specifically, the customer might select to receive notification via email at step 610, the customer might select to receive notification via an online messaging service at step 612, the customer might select to receive notification via a text messaging service at step 614, and the customer might select to receive notification via a facsimile method at step 616.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, certain notification methods might include an associated fee. Thus, a text message notification method might include an associated fee while an email notification method might not include an associated fee. Thus, a customer who desires a faster method of notification might pay a fee for that faster notification method.

Also for example, additional or other combinations of milestones are also contemplated. For example, a milestone that enables a customer to receive a photograph of an order system before the order is shipped might also be included as an option for a user to select.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing user configurable order status updates comprising:
presenting a plurality of status update options;
enabling a user to selectively choose from the plurality of status update options; and,
providing a customer with status updates based upon the status update options selected by the customer.

2. The method of claim 1, wherein
the plurality of status update options include milestone update options.

3. The method of claim 2, wherein
the milestone update options include at least one of an order received update milestone, a system starting assembly update milestone, a system beginning test milestone, a system completed test milestone, and a system shipped milestone.

4. The method of claim 1, wherein
the plurality of status update options include notification update options.

5. The method of claim 4, wherein
the notification update options include at least one of an email notification update, a text message notification update, a online message notification update and a facsimile notification update.

6. An apparatus for providing user configurable order status updates comprising:
means for presenting a plurality of status update options;
means for enabling a user to selectively choose from the plurality of status update options; and,
means for providing a customer with status updates based upon the status update options selected by the customer.

7. The apparatus of claim 6, wherein
the plurality of status update options include milestone update options.

8. The apparatus of claim 7, wherein
the milestone update options include at least one of an order received update milestone, a system starting assembly update milestone, a system beginning test milestone, a system completed test milestone, and a system shipped milestone.

9. The apparatus of claim 6, wherein
the plurality of status update options include notification update options.

10. The apparatus of claim 9, wherein
the notification update options include at least one of an email notification update, a text message notification update, a online message notification update and a facsimile notification update.

11. A system for providing user configurable order status updates comprising:
a presenting module, the presenting module presenting a plurality of status update options;
a selection module, the selection module for enabling a user to selectively choose from the plurality of status update options; and,
a status update module, the status update module providing a customer with status updates based upon the status update options selected by the customer.

12. The system of claim 11, wherein
the plurality of status update options include milestone update options.

13. The system of claim 12, wherein
the milestone update options include at least one of an order received update milestone, a system starting assembly update milestone, a system beginning test milestone, a system completed test milestone, and a system shipped milestone.

14. The system of claim 11, wherein
the plurality of status update options include notification update options.

15. The system of claim 14, wherein
the notification update options include at least one of an email notification update, a text message notification update, a online message notification update and a facsimile notification update.
